(19) United States
(12) Patent Application Publication
(10) Pub. No.: US 2008/0137327 A1
(43) Pub. Date: Jun. 12, 2008

(54) Grid-tied solar™ streetlighting

(76) Inventor: Michael Gerard Hodulik, Killington, VT (US)

Correspondence Address: Michael Hodulik, P.O. Box 579, Killington, VT, 05751, US

(21) Appl. No.: 11/903,126

(22) Filed: Sep. 20, 2007

Related U.S. Application Data
(60) Provisional application No. 60/846,279, filed on Sep. 22, 2006.

(51) Int. Cl. F21L 4/08

(52) U.S. Cl. 362/183

(57) ABSTRACT

The invention adds solar electric power generation to a streetlight which is attached to the power grid. The invention could either be a retro-fit to an existing streetlight, in which the solar panel and controller are attached as an option or a totally new design with integrated solar panel as part of the housing. The invention incorporates bi-directional power converter technology. This allows conversion of DC power from solar panels to AC for supplementing the power grid as well as AC to DC conversion to power a light.

### PRIOR APPLICATIONS

Applicant claims the benefit for the priority date of my earlier filed provisional patent application No. 60/846,279 filed Sep. 22, 2006.

### TECHNICAL FIELD

This invention relates generally to streetlights and more specifically to solar powered streetlights.

### BACKGROUND OF THE INVENTION

Streetlights can be found in abundance throughout the world. Most are in good un-obstructed solar collection locations. Streetlights are already connected to the power grid and have an infrastructure in place for installation, maintenance and service of them. Prior art references related to solar streetlights refer to a battery requirement needed to hold energy that is later delivered for night time use. These lights are convenient devices for new installations, but do not integrate well into an existing utility pole application.

These existing solar streetlights are designed to work isolated from the power grid. Their main attraction is to eliminate the need for providing trenching and their ability to work without using power from the utility grid. By providing a zero-energy resource, combined with longevity of the product means existing solar streetlights can theoretically pay for themselves over time. Realistically existing solar streetlights are more complicated than the standard streetlight, which can dramatically increase their initial and ongoing costs. Thus, payback can be longer then expected, sometimes extending past the lifetime of the product. Accordingly, there is a need for an improved solar streetlight design and method of doing business that relates thereto.

### SUMMARY OF THE INVENTION

The “grid-tied Solar™ streetlight” of the present invention is designed to depend on the power grid rather then be self-contained. For that matter, the battery requirement may be eliminated and replaced with the power grid. Similarly, the solar panel size is reduced in certain embodiments of the invention by being integrated into the light head. This can make installation on a utility pole easier. Although the “grid-tied Solar™ streetlight” does not provide an isolated zero-energy resource, is does offset its power usage with power generation, thus, reducing overall cost. The present invention can be more complicated than a standard streetlight, but not be as expensive to manufacture and maintain as the isolated solar streetlight. This invention could be thought of as meeting halfway and for lack of better terms, a hybrid solution.

### BRIEF DESCRIPTION OF THE DRAWING

The teachings of the present invention can be readily understood by considering the following detailed description in conjunction with the accompanying drawings, in which:

FIG. 1 shows one exemplary embodiment of a streetlight in accordance with the present invention;

FIG. 2 shows an exemplary retrofit embodiment of a streetlight in accordance with the present invention;

FIGS. 3-6 show various exemplary embodiments of a streetlight in accordance with the present invention;

FIG. 7 shows a “one-to-one” model of a grid tied solar streetlight;

FIG. 8 shows a “multiple-to-one” model of a grid tied solar streetlight;

FIGS. 9-12 show various component level diagrams of a grid tied solar streetlight in accordance with the present invention.

### DETAILED DESCRIPTION

The power requirements of current standard streetlights (100 watts or greater) means conversion to an isolated solar streetlight can be difficult because of the need for a large solar array to produce enough solar generated energy. Additionally, in existing solar streetlights, a battery needs to be used that is capable of storing several days' energy in case of inadequate solar coverage. As a result, existing solar-street lights are not typically as powerful as their standard grid-tied counterparts. Those lights that are as powerful need to mount large solar arrays which may not be an issue for current solar streetlights that work isolated from the power grid. Unfortunately, the battery and large solar panel are not installation friendly at typical utility pole power line applications. This issue can be reduced if the solar panel is built into the light head assembly as will be explained further in the context of the present invention, but such an arrangement may only provides about 2 sq. ft. of solar panel (area of light head). This may not be enough to provide the net power requirement of a current streetlight.

A unique of this invention is the large solar array and battery requirement can be eliminated once the solar-streetlight is tied to the power grid. Although not self-sufficient the “grid-tied Solar™ streetlight” can function as a normal streetlight by using power from the grid. Thus, it can use lights as powerful (or more powerful) as the standard streetlight. As a second function, during the daytime, the “grid-tied Solar™ streetlight” acts as a solar collector to power up the grid. Because it is connected to the grid, there is no need to generate the absolute power required to operate as with the isolated solar streetlight. By using a net metering strategy the power generated supplements the power grid and the net power requirement is reduced. This energy generation can be thought of as offsetting the energy usage of the “grid-tied Solar™ streetlight” at night. Therefore the rationale for collecting solar energy with this “grid-tied Solar™ streetlight” is different than existing solar streetlights. One offsets costs, while the other provides the system absolute power.

Power companies currently own and maintain an abundance of streetlights that are leased to customers. This includes townships, private companies and homeowners. There is an existing infrastructure related to streetlights. Interestingly, a small solar collection array can attach to the power grid in a similar way as existing streetlights do. Both need similar maintenance techniques that may require a telescoping bucket truck and expertise of personnel trained around power lines. So, combining the streetlight and small solar panel collection sites is a logical step from a maintenance viewpoint.

Generally, streetlights are a desired power load for the industry, since night time lighting means that generating equipment need not run idle, just to be ready to service the day time loads. Removing this load, as would be the case with isolated solar streetlights, is not necessarily a desired option for the power companies. On the other hand, power usage in the daytime, especially in the summer, is at a premium. Supplementing that power, even on a small scale, is a desirable effect to the power company. With the “grid-tied Solar™ streetlight” the night time load remains while supplementing the daytime usage. Therefore a grid-tied street light can be beneficial to the power company. Additionally the power generation helps provide localized power without the need of increased power transmission lines.

A design hurdle among the photo voltaic solar energy industry can be interconnection to the power grid. Unless the installation is isolated, any energy generated must get pushed back onto the power grid. Some power companies understandably become skeptical when they are not in control of the energy introduced into their grid. What if there was a simpler model for interconnection of small solar applications to the power grid?

Typical solar power grid-tied installations require the energy to be funneled through a meter. This is primarily for recording/monitoring and identifying the source so as to offset the utility bill (in net metering applications) or even pay the producer (in wholesale production). Streetlights are an unusual device in that many (e.g., those owned by the power company) do not require a meter. This is primarily because the costs to run a streetlight are fixed, and the extra burden of adding a meter, (plus cost of recording) would make existing streetlights more expensive to lease.

By connecting small solar applications to the grid, without the need of a power meter, this would reduce the complexity of tying to the grid, and reduce the overall cost. Although this simpler interconnection model does not let utilities account for solar energy production cost, the energy produced is used to offset street light energy costs. Thus, the model of a shared interconnection between streetlight and solar arrays without a meter can be achieved. In other words the power generated does not need to be accounted for fiscally (by meter) since it will be factored into the fixed cost of leasing a streetlight thus, bringing down the total cost of ownership for a streetlight. The power company in turn passes along these savings to the final customer/end user with a reduced lease. Theoretically, initial design studies of a grid-tied Solar™ streetlight with integrated panel into the light head could save a customer 25% power. Eventually as efficiencies improve and better lighting technologies emerge, the savings will improve. The goal would be to eventually save 100%. In other words a truly renewable device that provides all its own power. As would be understood, by a person skilled in the art, the streetlight design of the present invention could be metered, as well.

For increased savings, the housing of the present invention and solar collection material could be maximized to produce the most efficient power generation. This can be accomplished by two techniques. First the housing would be a flat surface (for example a trapezoid) or a non-flat surface (for example a cone, cube or ellipse) that would allow for maximum solar capture. Flat surfaces allow for mounting of standard flat silicon collection panels, while non-flat surfaces are better suited for flexible or even painted on solar collection material. It would be understood that other shapes could be used and that the shapes described are just examples. Second, there may be several models available for North, South, East, West mounting arrangements. This could also be accomplished by a single model with different attachment points so as to achieve proper mounting for maximum solar exposure.

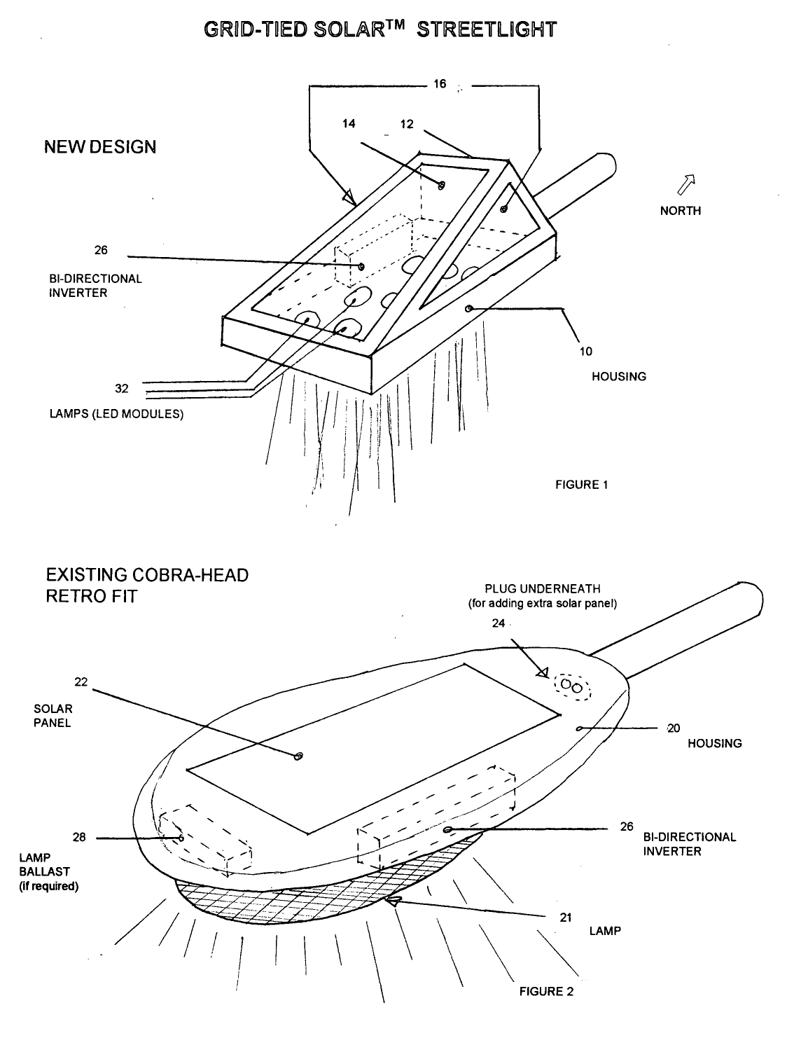

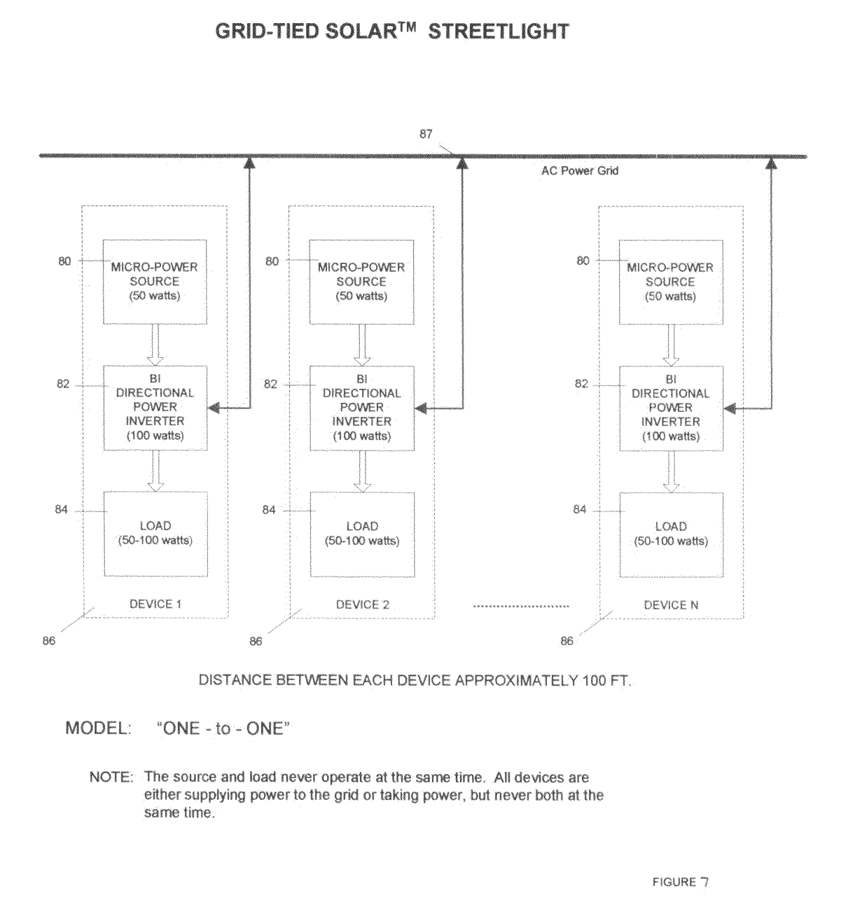

As for the housing shape and referring to FIGS. 1, 2 and 3, one exemplary arrangement is a trapezoid pyramid housing 10 with an offset peak 12 toward the back (most Northern point) of light. A top panel 14, with a gradual pitch, would have the most square area exposed to sun for mid afternoon conditions, while the adjacent smaller side panels 16, at a steeper pitch, would provide morning and afternoon maximum exposure. As shown in FIG. 3, the housing may have multiple connection points, for example, North, South, East and West and front and back, so that the housing may be mounted (e.g., via connection to a mounting post 18) in a manner which maximizes its Southern exposure.

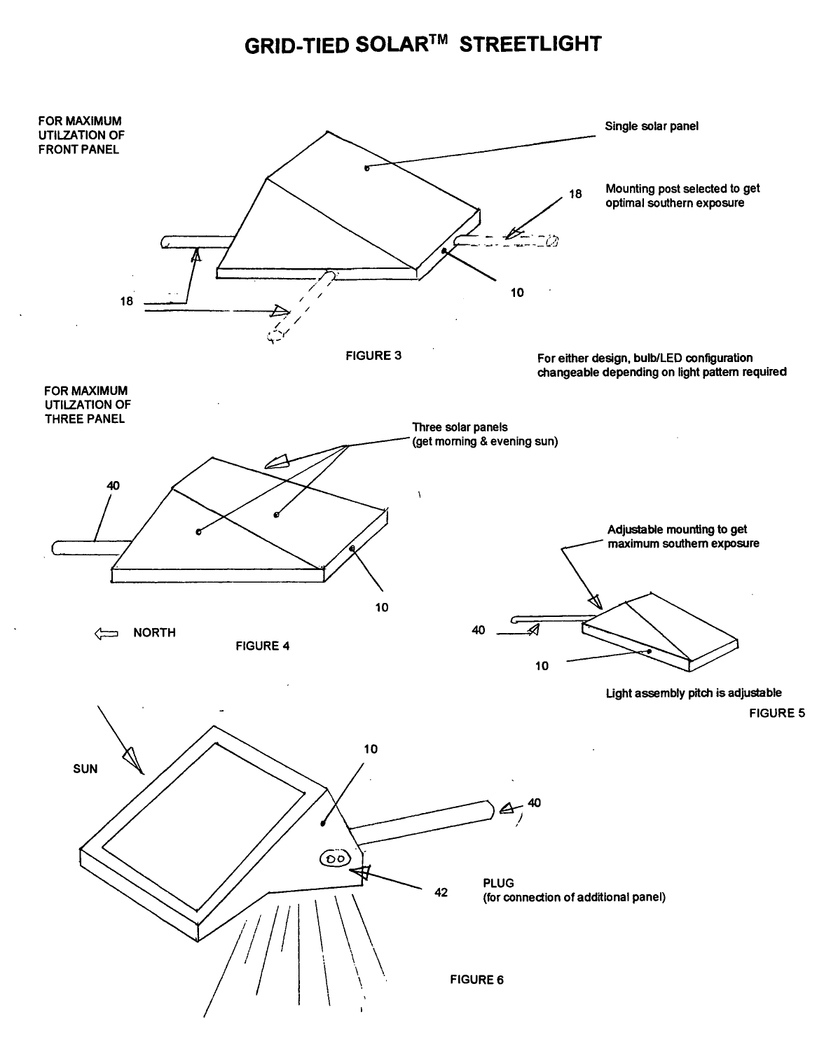

Referring to FIG. 2, the light used in the “grid-tied Solar™ streetlight” would initially use what is favored in the market. Currently this is typically high pressure sodium vapor, metal halide or incandescent light 21 as found in a typical cobra-head housing 20. As shown, the top of the housing 20 may include or have provisions to accept a solar panel 22. The housing 20 may also include a plug 24 for electrically coupling and/or attaching additional solar panels thereto. As shown in FIG. 2, the cobra-head housing would additionally contain a bidirectional inverter 26, as will be explained and a lamp ballast 28, if required by the type of lamp utilized.

Eventually as the LED streetlight gains market use, the light would switch to this technology. The LED light offers many other benefits to a “grid-tied Solar™ streetlight”. For instance, LED light requires special power requirements that can be addressed by the use of a bi-directional power inverter 30 as shown in FIG. 1. Current LED lights have to provide this as an addition, while for the “grid-tied Solar™ streetlight this would be an adaptation. FIG. 1 shows the trapezoid pyramid housing 10 having LED lamps 32 included therein. LED lights are advantageous since they generally use less power and can have a longer life expectancy than traditional lamps. As would be understood, traditional type lamps may also be utilized within the trapezoid pyramid housing as long as compatible electrical components are used.

Referring to FIGS. 3, 4, 5, and 6, the shape of the streetlight housing can affect it in many ways. It is desirable to have a housing that can provide functionality for orientation into the sunlight, cooling of the lighting device and electrical components and mounting of components with protection from the weather. FIGS. 3-6 show various manners of mounting the light assembly housing 10 to a lamp pole most likely via a post or posts 40 that attach or couple to a mast. FIG. 5 additionally illustrates that the light assembly housing 10 may be adjustable in relation to the mounting post 40 in order to maximize sunlight exposure. FIG. 6 shows a means, via plug 42, to attach addition solar arrays (not shown) by plugging in and mounting separately.

As discussed previously, one exemplary arrangement for a grid-tied streetlight of the present invention would be a trapezoid pyramid with an offset peak toward the back (most Northern point) of light. Top panel, at a gradual pitch, would have most square area exposed to sun for mid afternoon conditions, while the adjacent smaller side panels 16, at a steeper pitch, would provide morning and afternoon maximum exposure.

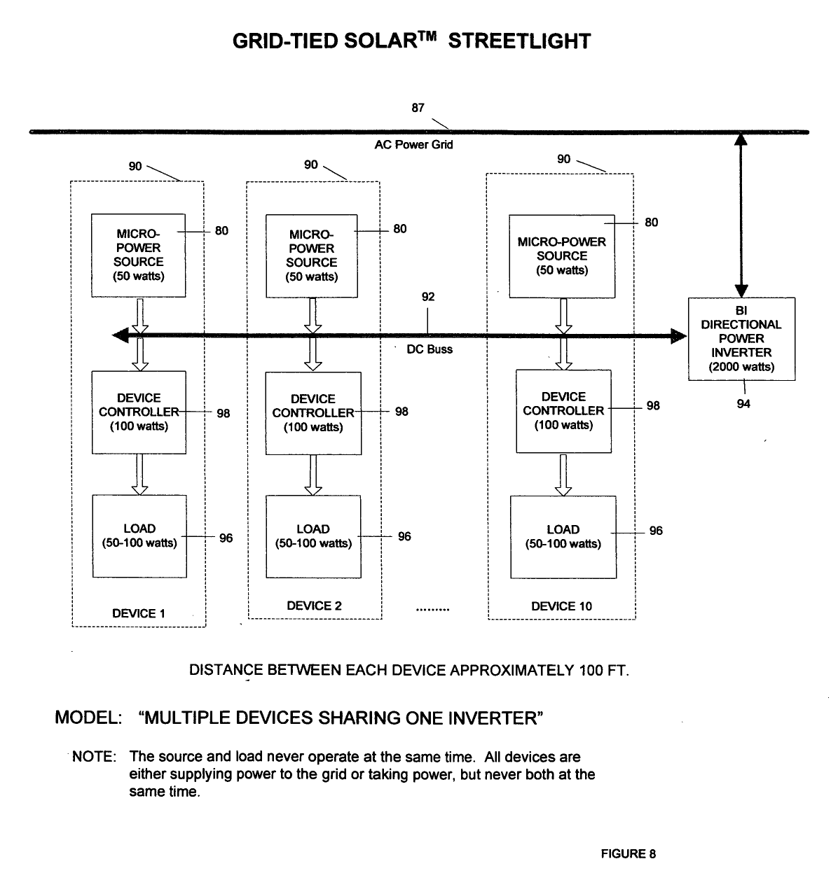

Shown in FIG. 7 are three of the major components for this product/device: an energy source 80, e.g. one or more solar panels, a power converter 82 and system load 84 being the light, each of which may be contained in a housing 86.

Two exemplary configurations are possible. The first configuration or model, “One-to-One”, has a “bi-directional power inverter” 82 on each device with multiple devices connected to the AC Power grid 86. Let's call this a “one-to-one” arrangement. This model allows for easier device installation, since each device is essentially a self-contained unit.

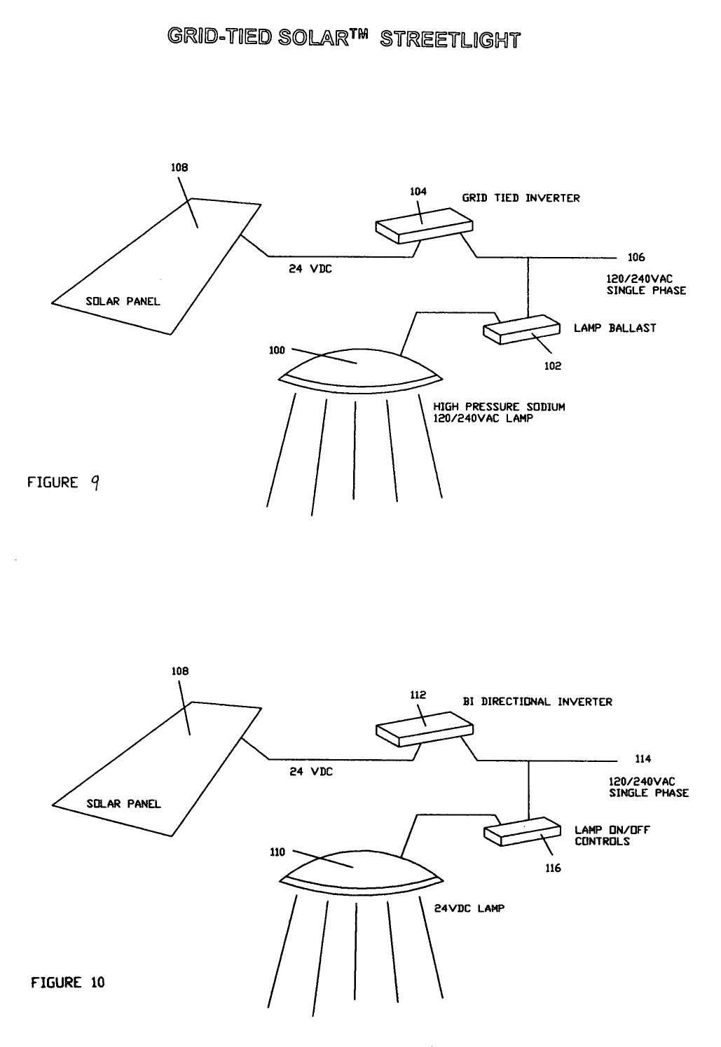

Referring to FIG. 8, the second model, “Multiple-to-One”, has multiple devices 90 tied together via DC bus 92 and sharing one “bi-directional power inverter” 94. This model assumes a DC power requirement for the light 96. In this case, a larger bi-directional power inverter 94 could be used, although there would probably be no more then 10 devices shared. A device controller 98 may include an integrated photo eye which turns on and switches off the light for night time operation. Additionally, the solar panel could also be used instead of the photo eye. This model may prove more economical since it saves on the amount of electronics as only a bi-directional inverter is needed for multiple streetlights.

### Various Component Models

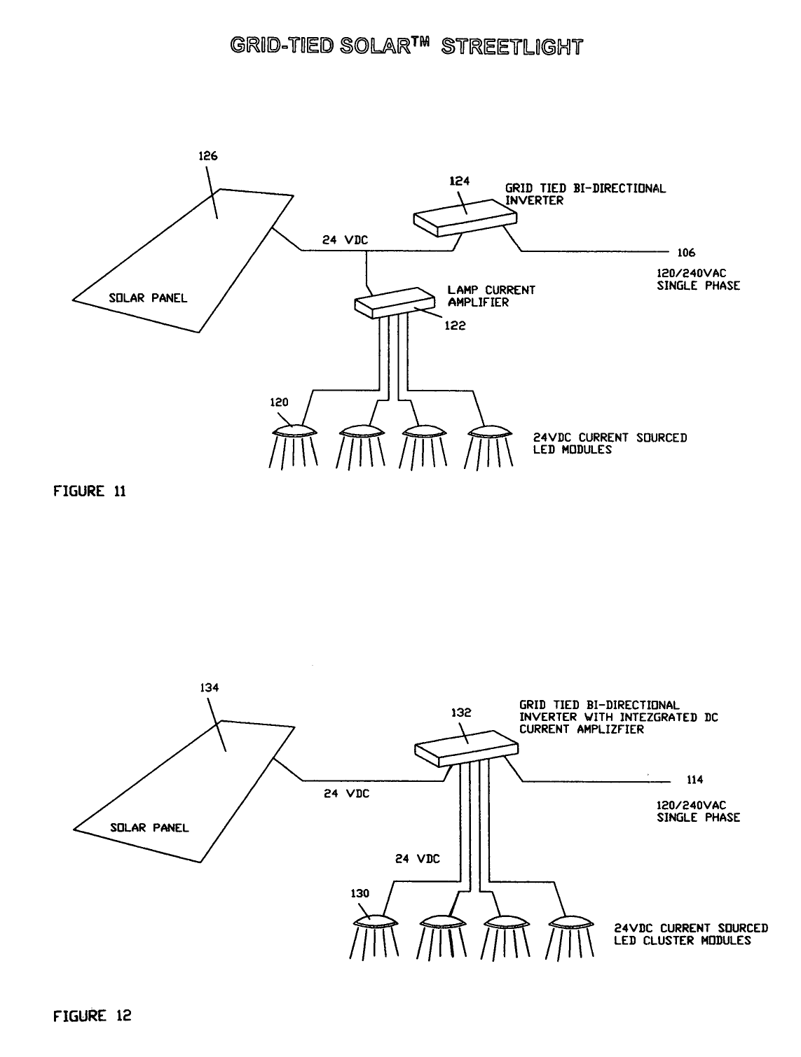

FIG. 9 shows a grid-tied inverter with standard lamp. This is the simplest of models using existing off the shelf technology and using a typical lamp assembly 100 in current streetlights having, for example, either high pressure sodium or Metal Halide and may also use a ballast 102 if required. This embodiment uses standard (non bi-directional) grid-tied inverter 104 for connection to grid 106 as well as to the solar panel 108.

Another embodiment of the invention shows a grid-tied arrangement with bi-directional inverter with 24Vdc lamp as shown in FIG. 10. This is more complicated than the embodiment of FIG. 9 and uses some new technology. This arrangement uses a 24Vdc lamp 110 (not typical for existing streetlights). It also uses a bi-directional inverter 112 to transfer solar power to the grid 114 and supply power for the 24Vdc lamp, where all components on the non-grid side of the device operate at 24Vdc.

FIG. 11 shows a grid-tied bi-directional inverter with 24Vdc current source LED clusters. This arrangement is more complicated than the previous two embodiments and uses 24Vdc current sourced LED modules 120. The arrangement in FIG. 11 needs a special current amplifier 122 to source the LED's 120 and also uses special LED modules in which LED's are mounted in clusters to make a multiple concentrated LED light sources. Modules can be aimed for a desired lighting pattern. Modules will aid to modularize the LED lamp, rather then use one large continuous array, although the continuous array can still be used if desired This embodiment uses a bi-directional inverter 124 to transfer solar power to grid 126 and supply power to a current amplifier 122 needed to source the LED lamps 120. All components are 24Vdc.

FIG. 12 shows a Grid-tied Bi-Directional Inverter/Current Amplifier with 24Vdc Current Sourced LED Clusters. This the most complicated embodiment and uses 24Vdc current sourced LED clusters 130. The arrangement uses a special current amplifier (integrated into bi-directional inverter 132) to source LED's 130. The arrangement includes special LED clusters mentioned in previous paragraph and uses a bi-directional inverter 132 with current amplifier to transfer solar power to grid 134 and supply current source to power for 24Vdc LED lamps 130. All components are 24Vdc.

The foregoing description merely illustrates the principles of the invention. It will thus be appreciated that those skilled in the art will be able to devise various arrangements, which, although not explicitly described or shown herein, embody the principles of the invention, and are included within its spirit and scope. Furthermore, all examples and conditional language recited are principally intended expressly to be only for instructive purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein. Many other modifications and applications of the principles of the invention will be apparent to those skilled in the art and are contemplated by the teachings herein. Accordingly, the scope of the invention is limited only by the claims.

What is claimed is:

1. A streetlight apparatus comprising:
a solar collection unit for collecting solar energy;
a power converter coupled to said solar collection unit and to an AC power grid for enabling energy collected from said solar collection unit to be channeled onto said AC power grid as electricity; and
a light source coupled to said power converter which receives electricity from said AC power grid for operation thereof.

2. The apparatus of claim 1, wherein said power converter is a bi-directional power inverter.

3. The apparatus of claim 2, wherein said bi-directional power inverter couples to multiple separate streetlights through a power bus, said power bus being coupled to multiple solar collection units and multiple light sources.

4. The apparatus of claim 1, wherein said light source is included within a device housing, said device housing being shaped in order to include solar collection units thereon to maximize exposure to the sun.

5. The apparatus of claim 4, wherein said housing includes multiple flat surfaces thereon, wherein multiple solar collection units are coupled to said multiple flat surfaces.

6. The apparatus of claim 4, wherein the housing is in the shape of a trapezoidal pyramid.

7. The apparatus of claim 1, wherein the light source include LEDs.

8. The apparatus of claim 7, further including a DC power amplifier for use in powering said LEDs.

9. The apparatus of claim 4, wherein said housing includes multiple connection points for mounting thereof.

10. The apparatus of claim 4, wherein said connection points enable said housing to be move orientation of said housing.

11. A method for operating a streetlight including the steps of:
providing a solar collection unit for collecting solar power;
providing a power converter coupled to said solar collection unit and to an AC power grid for enabling energy collected from said solar collection unit to be channeled onto said AC power grid as electricity; and
providing a light source coupled to said power converter which receives electricity from said AC power grid for operation thereof.

12. The method of claim 11, wherein said streetlight is operated without a meter, wherein the cost benefit from electricity produced from said solar collection device is factored into the operational costs of the streetlight, thereby providing a more economically efficient business model for operating a streetlight.

13. The method of claim 11, wherein said power converter is a bi-directional power inverter.

14. The method of claim 13, wherein said bi-directional power inverter couples to multiple separate streetlights through a power bus, said power bus being coupled to multiple solar collection units and multiple light sources.

15. The method of claim 11, wherein said light source is included within a device housing, said device housing being shaped in order to include solar collection units thereon to maximize exposure to the sun.

16. The method of claim 15, wherein said housing includes multiple flat surfaces thereon, wherein multiple solar collection units are coupled to said multiple flat surfaces.

17. The method of claim 15, wherein said housing includes non-flat surfaces thereon, wherein multiple non-flat or flexible solar collection units or techniques are coupled to said non-flat surfaces.

18. The method of claim 16, wherein the housing is in the shape of a trapezoidal pyramid.

19. The method of claim 12, wherein the business model is for leased streetlights.
